(19) United States
(12) Patent Application Publication
(10) Pub. No.: US 2020/0007608 A1
(43) Pub. Date: Jan. 2, 2020

(54) SYSTEM AND METHOD FOR PERFORMING FAST FILE TRANSFERS

(71) Applicant: R-Stor Inc., Saratoga, CA (US)

(72) Inventor: Roger Levinson, San Jose, CA (US)

(21) Appl. No.: 16/435,305

(22) Filed: Jun. 7, 2019

Related U.S. Application Data
(60) Provisional application No. 62/692,434, filed on Jun. 29, 2018.

(51) Int. Cl. H04L 29/08; H04L 29/06; H04L 12/927

(52) U.S. Cl. CPC H04L 67/06; H04L 63/0428; H04L 67/02; H04L 67/1097; H04L 67/24; H04L 47/805

(57) ABSTRACT

Systems and apparatus for performing fast file transfers and methods for making and using the same. In various embodiment, the system advantageously can eliminate distance constraints between multi-site computational environments and provide a dramatic reduction in transfer among other things.

### CROSS-REFERENCE TO RELATED APPLICATIONS

This application claims the benefit of, and priority to, U.S. Provisional Application Ser. No. 62/692,434, filed Jun. 29, 2018, the disclosure of which is hereby incorporated herein by reference in its entirety and for all purposes.

### FIELD

The present disclosure relates generally to digital data processing and more particularly, but not exclusively, to high-efficiency, high-bandwidth systems and methods for storing and rapidly moving large data sets across multiple remote locations.

### BACKGROUND

Conventional legacy data transport systems allow data to be exchanged between remote system resources. While giving significant attention to the data, these data transport systems fail to focus sufficient attention on communications, particularly communications via wide area network (or WAN). The philosophy of these data transport systems is that, if the data cannot be moved “as is,” the data must be compressed, manipulated, broken up or otherwise pre-processed. Pre-processing data, however, takes time, impacts compute resources and delays access to data. Furthermore, some types of data, such as previously-compressed data or encrypted data, cannot be manipulated. Attempts to over-manipulate these types of data result in a loss of integrity and data corruption.

In view of the foregoing, a need exists for an improved system and method for performing fast file transfers in an effort to overcome the aforementioned obstacles, challenges and deficiencies of conventional data processing systems.

### BRIEF DESCRIPTION OF THE DRAWINGS

FIG. 1A is an exemplary top-level drawing illustrating an embodiment of a data storage and transfer system for storing and rapidly moving large data sets across multiple remote locations.

FIG. 1B is an exemplary top-level drawing illustrating an alternative embodiment of the data storage and transfer system of FIG. 1A, wherein the data storage and transfer system is enabled to transfer a selected file.

FIG. 2 is an exemplary top-level drawing illustrating another alternative embodiment of the data storage and transfer system of FIG. 1A, wherein the data storage and transfer system comprises a plurality of points of presence that are distributed around the world.

It should be noted that the figures are not drawn to scale and that elements of similar structures or functions are generally represented by like reference numerals for illustrative purposes throughout the figures. It also should be noted that the figures are only intended to facilitate the description of the preferred embodiments. The figures do not illustrate every aspect of the described embodiments and do not limit the scope of the present disclosure.

### DETAILED DESCRIPTION

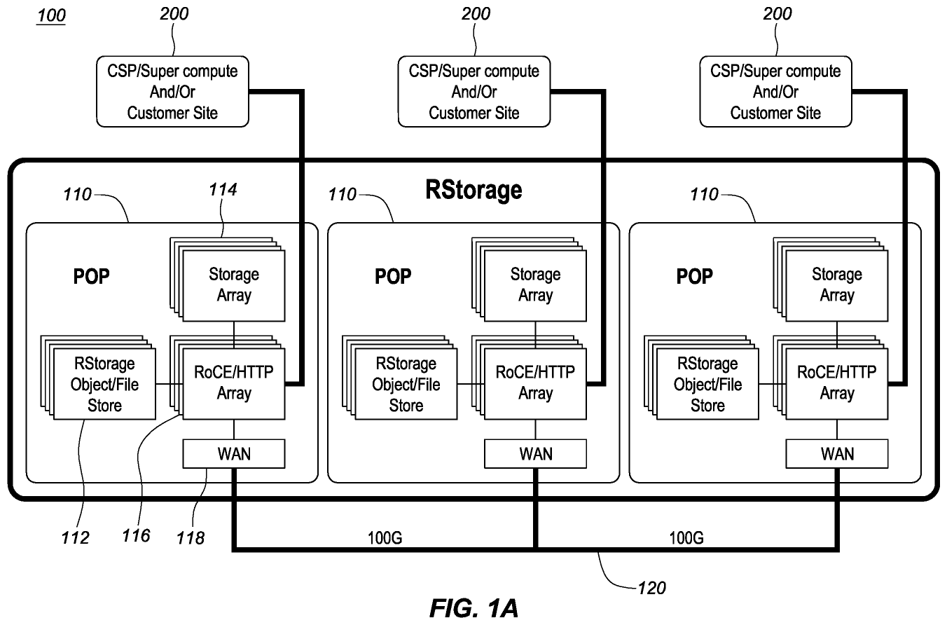

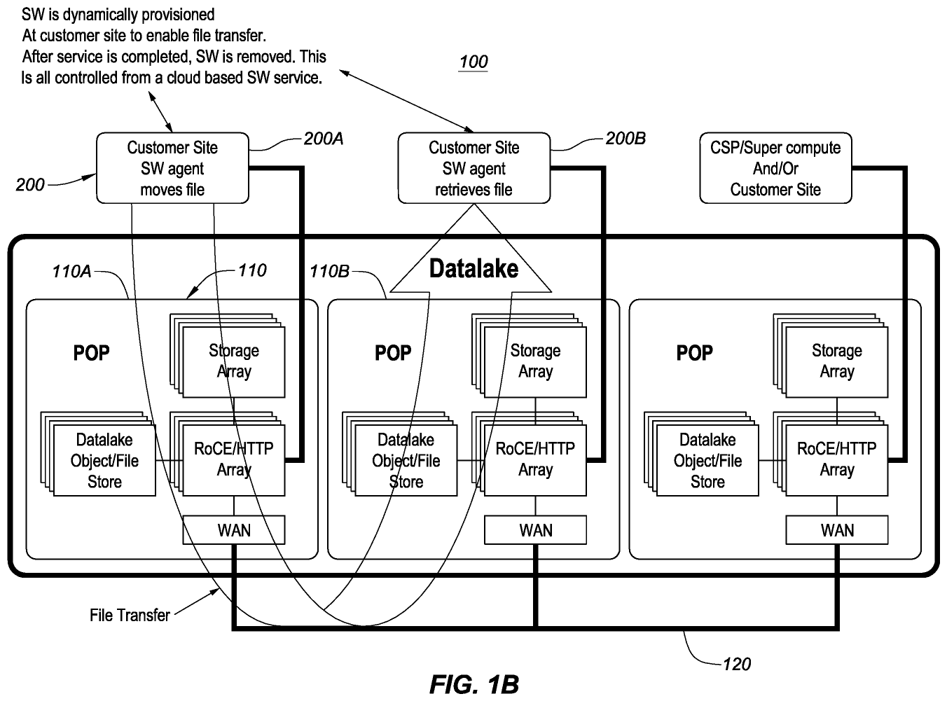

Since currently-available legacy data transport systems require data to be compressed, manipulated, broken up or otherwise pre-processed and can result in a loss of integrity and data corruption, a high-efficiency, high-bandwidth system and method that can perform fast file transfers between private data centers and public cloud device providers can prove desirable and provide a basis for a wide range of computer applications, including cloud-based applications. This result can be achieved, according to one embodiment disclosed herein, by a data storage and transfer system 100 as illustrated in FIG. 1A.

Turning to FIG. 1A, the data storage and transfer system 100 can support a family of services riding on a high-efficiency, high-bandwidth network between private data centers and public cloud service providers. The high-efficiency, high-bandwidth network allows users to easily move and store large data sets with predictable performance and pricing. In one embodiment, the data storage and transfer system 100 advantageously allows users to move data “as is,” without compressing or breaking up files. In one embodiment, if the data does not successfully transfer on a first attempted data transfer, the data storage and transfer system 100 can attempt to retransmit the data. The data storage and transfer system 100, for example, can make a predetermined number of attempts to retransmit the data and, if unsuccessful, can escalate any unsuccessful data transfer for further attention.

Selected resources of the data storage and transfer system 100 can be located outside, but accessible (preferably, securely accessible) to, one or more external network resources 200, such as cloud service providers (CSPs), such as Amazon Web Services (AWS), Azure, and Google Cloud Computing (GCP), Supercomputing Centers, such as Texas Advanced Computing Center (TACC) and San Diego Supercomputer Center (SDSC), and/or on-premises Enterprise customer sites, without limitation. The external network resources 200 can seamlessly connect with the data storage and transfer system 100 in any conventional manner, including through colocation cross connections, select metro Ethernet rings, and/or standard Internet. For a user who already owns a fiber interconnect, for example, the data storage and transfer system 100 can cross connect with an external network resource 200 of the user via a convenient colocation facility, enabling the external network resources 200 to utilize the long distance accelerated fabric of the data storage and transfer system 100. The data storage and transfer system 100 advantageously can use a fast fabric infrastructure to efficiently move data to compute and/or compute to data.

The data storage and transfer system 100 advantageously can eliminate distance constraints between multi-site computational environments. By eliminating these distance constraints, the data storage and transfer system 100 can enable secure replication of data and/or foster an environment that promotes easy collaboration between users who want access to a common pool of data over wide area distances. Data security can be further ensured, for example, via use of user keys and/or Advanced Encryption Standard (AES)-256 encryption.

The data storage and transfer system 100 preferably stores the data temporarily as needed to help ensure that the full data transfer has completed. The data then can be deleted once the data transfer is complete. The data storage and transfer system 100 likewise can provide robust, distributed file storage services for enhanced data security. With the remote mount capability of the data storage and transfer system 100, the data can be stored in a secure location with limited portions of the data being accessible for computation directly by a remote computer through Remote Direct Memory Access (RDMA). Since the data is not copied in whole and is not stored elsewhere, data sovereignty can be maintained.

The data storage and transfer system 100 can provide a dramatic reduction in transfer times versus standard Transmission Control Protocol/Internet Protocol (TCP/IP) data transfer rates without requiring significant (or, preferably, any) network changes. In selected embodiments, the data storage and transfer system 100 can utilize one or more proprietary data protocols, including RDMA, to eliminate overhead and inefficiencies inherent in transport protocols, such as TCP/IP, while maintaining routability and managing congestion and packet loss. Thereby, the data storage and transfer system 100 can provide tangible business advantages, both in terms of sheer volume of data that can be handled and the speed at which the volume of data can be moved.

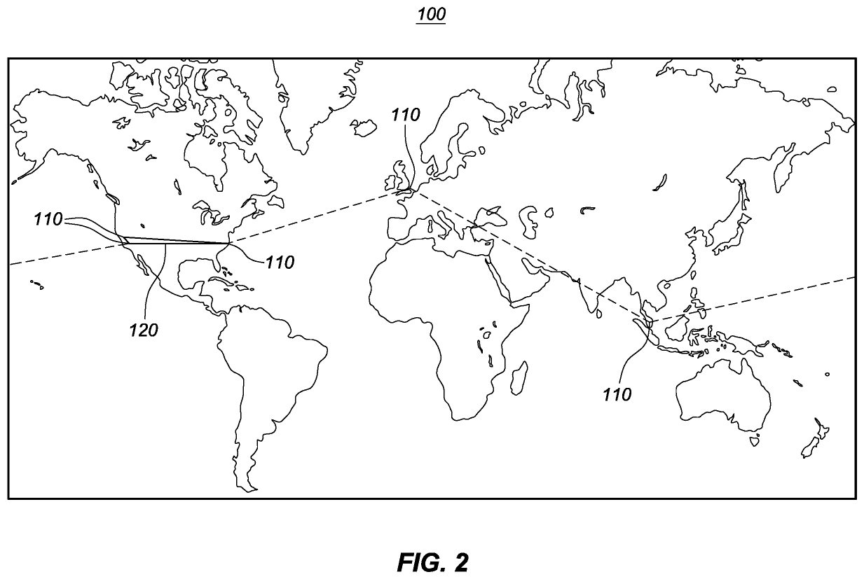

The embodiment of the data storage and transfer system 100 of FIG. 1A is shown as comprising a plurality of points of presence (POPs) 110 that are connected by, and communicate via, a communication connection 120. The points of presence 110 can be disposed at multiple geographic locations. Preferably, the points of presence 110 are geographically remote and can be distributed at any suitable geographic locations around the world as illustrated in FIG. 2. Each of the points of presence 110 includes proprietary networking equipment that enables extremely fast transport between the multiple geographic locations, such as geographic regions including North America, Europe and Asia. Exemplary geographic locations can include geographic locations disposed at a border (or coast) and/or inland (or interior) of a selected geographic region.

Returning to FIG. 1A, each point of presence 110 can include an object/file store system 112, a storage array system 114, and a Remote Direct Memory Access over Converged Ethernet (RoCE)/Hypertext Transfer Protocol (HTTP) array system 116. The points of presence 110 can communicate with the communication connection 120 directly and/or, as illustrated in FIG. 1A, via one or more intermediate systems, such as a Wide Area Network (WAN) system 118. Each point of presence 110 can be associated with a respective Wide Area Network system 118, which can be separate from, and/or at least partially integrated with, the relevant point of presence 110.

Each Wide Area Network system 118 can enable a user to remote mount compute to data, in geographically diverse locations. The Wide Area Network systems 118 thereby can eliminate a need to transfer entire datasets for individual runs. This functionality can provide a significant improvement in price and/or performance for distributed Enterprise Performance Computing™ (EPC) workloads and/or can solve some fundamental data sovereignty and privacy challenges, such as General Data Protection Regulation (GDPR) and/or Health Insurance Portability and Accountability Act (HIPPA). In one embodiment, the Wide Area Network systems 118 can provide data acceleration based upon a hardware and/or software solution extending InfiniBand (IB) and RDMA over converged Ethernet (RoCE) from a Local Area Network (LAN) of each point of presence 110 to the WAN supported by the communication connection 120. Additionally and/or alternatively, the points of presence 110 and/or the communication connection 120 can support Layer 2 (Ethernet and IB) and/or Layer 3 (TCP/IP) connections. By introducing no additional latency, the data storage and transfer system 100 can offer up to 95% (or more) bandwidth utilization independent of distance while supporting up to 10 Gbps (or higher) service.

The RoCE/HTTP array system 116 can be configured to communicate with, and exchange data with, the object/file store system 112 and/or the storage array system 114. In one embodiment, the object/file store system 112 can provide a distributed file and/or object storage solution. The object/file store system 112, for example, can include a user-accessible policy manager to control one or more (preferably all) aspects of data storage, distribution, access, and/or persistence. The points of presence 110 advantageously can provide orders of magnitude reduction in data transport times versus traditional protocols, such as the Transmission Control Protocol/Internet Protocol (TCP/IP) protocols. Additionally and/or alternatively, the points of presence 110 can support multiple and/or easy methods to on-ramp to (and/or off-ramp from) the external network resources 200, greatly improving user experience. The data storage and transfer system 100 thereby can provide a parallel file system and object storage system that supports geographic replication and/or erasure coding for maintaining system resiliency and reliability.

Turning to FIG. 1B, the data storage and transfer system 100 is shown as being enabled to provide a cloud-based service for facilitating transfer a selected file from a source network resource (or customer/user site) 200A to a destination network resource (or customer/user site) 200B. When enabled by a user, the data storage and transfer system 100 can download a containerized software engine to both network resources 200A, 200B for transferring the selected file through the fabric of the data storage and transfer system 100 from the source network resource 200A to the destination network resource 200B. The user need only interact with the data storage and transfer system 100 through a simple web user interface.

The data storage and transfer system 100 thereby can transfer files from the source network resource 200A to the destination network resource 200B in a manner that is controlled remotely, such as via the cloud. Additionally and/or alternatively, the network resources 200A, 200B can comprise third party sites, such as cloud service providers. In one embodiment, the data storage and transfer system 100 can utilize a containerized version of the file transfer software that can be dynamically downloaded to the network resource 200 to perform the file transfer function and then can be deleted.

The data storage and transfer system 100 can include an ability to begin accessing the file at the destination network resource 200B prior to the complete transfer of the file. Further information about the file processing is set forth in U.S. patent application Ser. No. 16/002,808, filed on Jun. 7, 2018, the disclosure of which is incorporated herein by reference in its entirety and for all purposes. The software that is installed at the network resource 200 can include file transfer acceleration technology to reduce the time taken to move the file across long distances.

Although various implementations are discussed herein and shown in the figures, it will be understood that the principles described herein are not limited to such. For example, while particular scenarios are referenced, it will be understood that the principles described herein apply to any suitable type of computer network or other type of computing platform, including, but not limited to, a Local Area Network (LAN), a Wide Area Network (WAN), a Wireless Local Area Network (WLAN), a Metropolitan Area Network (MAN) and/or a Campus Area Network (CAN).

Accordingly, persons of ordinary skill in the art will understand that, although particular embodiments have been illustrated and described, the principles described herein can be applied to different types of computing platforms. Certain embodiments have been described for the purpose of simplifying the description, and it will be understood to persons skilled in the art that this is illustrative only. It will also be understood that reference to a “server,” “computer,” “network component” or other hardware or software terms herein can refer to any other type of suitable device, component, software, and so on. Moreover, the principles discussed herein can be generalized to any number and configuration of systems and protocols and can be implemented using any suitable type of digital electronic circuitry, or in computer software, firmware, or hardware. Accordingly, while this specification highlights particular implementation details, these should not be construed as limitations on the scope of any invention or of what may be claimed, but rather as descriptions of features that may be specific to particular embodiments of particular inventions.

What is claimed is:

1. A method for rapidly moving a large data set, comprising:
receiving the data set from a first network resource; and
transmitting the received data set to a second network resource,
wherein the received data set is transmitted to the second network resource as an unbroken data set.

2. The method of claim 1, wherein said transmitting the received data set comprises transmitting the received data set without partitioning the received data set into multiple data set portions during transmission to the second network resource.

3. The method of claim 1, wherein the data set is received from the first network resource as an unbroken data set.

4. The method of claim 1, wherein the data set is transferred from the first network resource to the second network resource without compressing the data set.

5. The method of claim 1, further comprising determining whether the data set has been successfully transferred and retransmitting the received data set based upon said determining.

6. The method of claim 5, wherein said retransmitting the received data set comprises repeatedly retransmitting the received data set for a predetermined number of times and until the data set has been successfully transferred.

7. The method of claim 1, wherein said receiving the data set includes receiving the data set from the first network resource in an encrypted format, and wherein said transmitting the received data set includes transmitting the received data set to the second network resource in the encrypted format.

8. The method of claim 1, further comprising storing the received data set and deleting the stored data set after the data set has been successfully transferred.

9. The method of claim 8, wherein said storing the received data set includes storing the received data set via a distributed data storage system.

10. The method of claim 9, wherein said storing the received data set includes partitioning the received data set into a predetermined number of data set portions and storing the data set portions in respective secure data storage systems of the distributed data storage system.

11. The method of claim 1, wherein said receiving the data set includes receiving the data set via one or more proprietary data protocols, and wherein said transmitting the received data set includes transmitting the received data set via the one or more proprietary data protocols.

12. The method of claim 11, wherein the proprietary data protocols include Remote Direct Memory Access (RDMA).

13. A computer program product for rapidly moving a large data set, the computer program product being encoded on one or more non-transitory machine-readable storage media and comprising:
instruction for receiving the data set from a first network resource; and
instruction for transmitting the received data set to a second network resource,
wherein the received data set is transmitted to the second network resource as an unbroken data set.

14. A system for rapidly moving a large data set, comprising:
a first point of presence for receiving the data set from a first network resource; and
a second point of presence for transmitting the received data set to a second network resource and being in communication with said first point of presence via a communication connection,
wherein said second point of presence transmits the received data set to the second network resource as an unbroken data set.

15. The system of claim 14, wherein said first point of presence is disposed at a first predetermined geographic location, and wherein said second point of presence is disposed at a second predetermined geographic location being geographically remote from the first predetermined geographic location.

16. The system of claim 14, wherein said first point of presence includes a file store system for providing distributed file storage and an array system for receiving the data set from the first network resource and transmitting the received data set to said second point of presence, and wherein said second point of presence includes a file store system for providing distributed file storage and an array system for receiving the received data set from said first point of presence and transmitting the received data set to second network resource.

17. The system of claim 16, wherein said file store system of said first point of presence and said file store system of said point of presence each includes a user-accessible policy manager for controlling selected aspects of data storage, distribution, access, persistence or a combination thereof.

18. The system of claim 16, wherein said array system of said first point of presence and said file store of said point of presence each supports a Remote Direct Memory Access over Converged Ethernet (RoCE) communication protocol, Hypertext Transfer Protocol (HTTP) communication protocol or both.

19. The system of claim 16, wherein said array system of said first point of presence and said array system of said second point of presence indirectly communicate with the communication connection via respective Wide Area Network (WAN) systems.

20. The system of claim 14, wherein the first network resource, the second network resource or both includes a customer site, a user site, cloud service provider system, a supercomputing system or a combination thereof.
